(19) United States
(12) Patent Application Publication
(10) Pub. No.: US 2020/0272104 A1
(43) Pub. Date: Aug. 27, 2020

(54) TIMEPIECE

(71) Applicant: CITIZEN WATCH CO., LTD., Tokyo (JP)

(72) Inventors: Kaori Aoba, Tokyo (JP); Yasushi Tomiyama, Abiko-shi (JP); Hideki Inoue, Tokyo (JP)

(21) Appl. No.: 16/284,547

(22) Filed: Feb. 25, 2019

(51) Int. Cl. G04B 19/10; G04B 19/06; G04B 19/08

(52) U.S. Cl. CPC G04B 19/10; G04B 19/08; G04B 19/065

(57) ABSTRACT

A timepiece includes a dial plate including a first index on a radial virtual line outwardly extending from a center; and a circular case ring disposed outside of the dial plate, the circular case ring including a second index arranged in series with the first index on the line, wherein the second index includes a proximal end facing the first index; and a distal end opposite the proximal end, wherein a width of the proximal end is wider than that of the distal end in a plan view as seen in a height direction of the dial plate, and wherein the width of the proximal end of the second index is wider than that of a proximal end of the first index facing the second index.

### FIELD OF THE INVENTION

The present disclosure relates to a timepiece.

### BACKGROUND

A timepiece indicates time by pointing at markers or indicators with hands such as an hour hand and a minute hand. The markers include smaller markers disposed in positions which are separated each other with one-minute intervals (corresponding to one minute of the minute hand which rotates once in every sixty minutes) and larger markers (hereinafter referred to as indices) disposed in positions which are separated each other with five-minute intervals (corresponding to one hour of the hour hand which rotates once in every twelve hours).

In addition to the markers or indices on a dial plate, the indices may be disposed on a circular member such as a case ring which is provided on the outer circumferential part of the dial plate or in a position outward from the dial plate. Further, the indices may be disposed both on the dial plate and the circular member. In the timepiece where the indices are disposed both on the dial plate and the circular member, the indices of the dial plate and the indices of the circular member are arranged in series on a line which radially extends from the center (the rotational center of the hands) of the dial plate, which gives a viewer or user an impact in terms of its design (see Patent Literature 1: JP2007-124011A, for example).

The dial plate and the circular member are separate parts, so that the dial plate and the circular member may be displaced or misaligned relative to each other when the timepiece is assembled. For example, after the dial plate is fixed to a case of the timepiece, the circular member is placed within the case and then a grass or crystal is fixed to the case. A waterproof seal is generally provided between the crystal and the case. When the crystal is fixed to the case, the crystal is compressed into the case, which elastically deforms the seal. At this time, the movement of the crystal and the seal slightly rotates the circular member unexpectedly.

As a result, the indices of the dial plate and the indices of the circular member, which are supposed to be arranged in series on the line radially extending from the center of the dial plate, are displaced or misaligned relative to each other in a rotational direction (circumferential direction). The indices of the dial plate and the indices of the circular member may also be displaced relative to each other as described above due to machining accuracy of the circular member, the indices on the circular member and the like even if another positioning structure is used for the circular member. The displacement or misalignment between the indices on the dial plate and the indices on the circular member deteriorates quality in the appearance of the timepiece.

The present disclosure has been made in view of the above issues, and accordingly an object of the present disclosure is to provide a timepiece which can suppress deterioration of quality in the appearance of the timepiece even if the indices on the dial plate and the indices on the circular member are displaced or misaligned relative to each other.

### SUMMARY OF THE INVENTION

A timepiece of the present disclosure includes a dial plate including a first index on a radial line outwardly extending from a center; and a circular member disposed outside of the dial plate and extending at least partially circularly, the circular member including a second index arranged in series with the first index on the radial line, wherein the second index includes a proximal end facing the first index and a distal end opposite the proximal end, wherein a width of the proximal end is wider than that of the distal end in a plan view as seen in a height direction of the dial plate, and wherein the width of the proximal end of the second index is wider than that of a proximal end of the first index facing the second index.

### BRIEF DESCRIPTION OF THE DRAWINGS

FIG. 1 is a plan view illustrating a wristwatch according to an embodiment of the present disclosure.

FIG. 2 is a cross-sectional view along a line A-A in FIG. 1.

FIG. 3 is a perspective view illustrating a second index in a case ring.

FIG. 4 is a plan view illustrating a first index and the second index.

FIG. 5 is a plan view corresponding to FIG. 4 and illustrating another example of a wider portion in the second index.

FIG. 6 is a plan view corresponding to FIG. 4 and illustrating yet another example of a wider portion in the second index.

FIG. 7 is a plan view illustrating a first index and a second index according to a second embodiment of the present disclosure and corresponding to FIG. 4.

FIG. 8 is a plan view corresponding to FIG. 4 and illustrating another example of a second index.

FIG. 9 is a plan view corresponding to FIG. 4 and illustrating another example of a first index.

### DETAILED DESCRIPTION

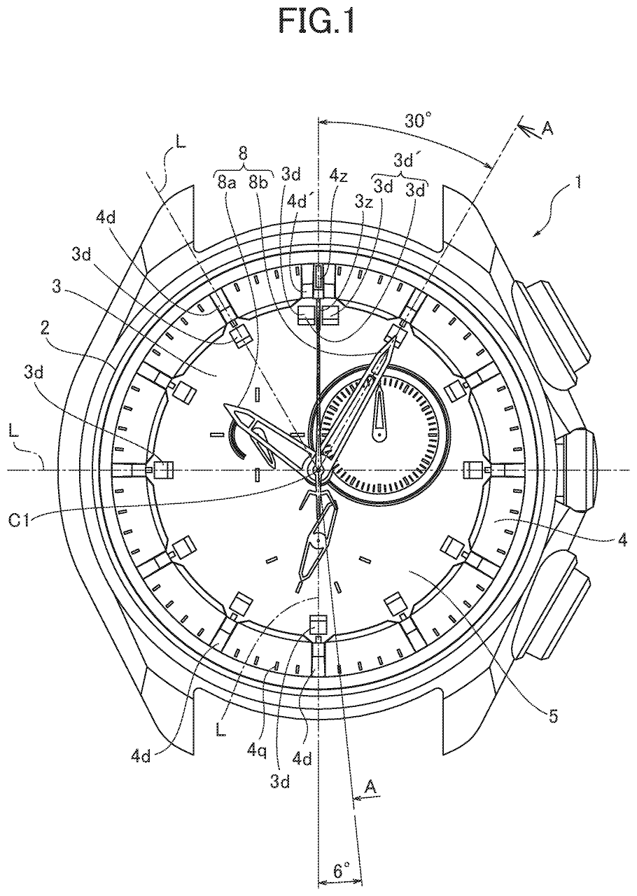

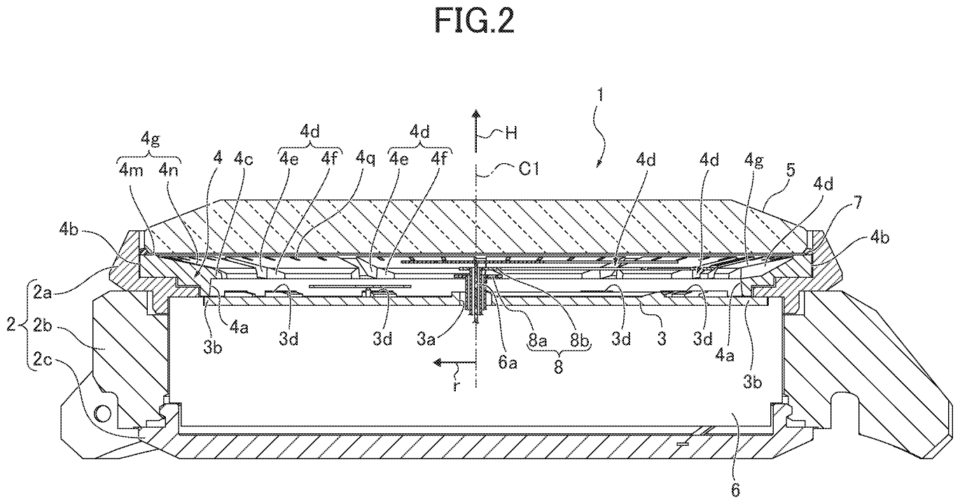

Hereinafter, embodiments of a timepiece according to the present disclosure will be described with reference to the accompanying drawings. FIG. 1 is a plan view illustrating a wristwatch 1 according to an embodiment of the present disclosure. FIG. 2 is a cross-sectional view along a line A-A in FIG. 1. The wristwatch 1 includes a case 2, a grass or crystal 5, a movement 6, a dial plate 3, a dial ring or case ring 4 (an example of a circular member), and a hand 8 (including a hour hand 8a and a minute hand 8b). The wristwatch 1 includes smaller hands for functions different from the time display function. However, the smaller hands will not be described since such hands do not directly relate to the present disclosure.

The case 2 includes an upper circular portion 2a, a lower circular portion 2b provided in a position below the upper circular portion 2a, and a back cover or case back 2c attached to the lower circular portion 2b. The movement 6 is placed within a space defined by the lower circular portion 2b and the case back 2c.

The dial plate 3 is disposed in the upper side of the movement 6. The case ring 4 is formed in an uninterrupted circular form. The case ring 4 is disposed in a position above an outer portion 3b of the dial plate 3 and inside the upper circular portion 2a to cover the outer circumferential edge of the dial plate 3. The crystal 5 is disposed in a position above the case ring 4 and inside the upper circular portion 2a with a seal 7 disposed between the crystal 5 and the upper circular portion 2a. The seal 7 also contacts to the case ring 4. The seal 7 is made of an elastic material for waterproofing.

The dial plate 3 includes a center opening 3a in a center C1 through which a rotating shaft 6a extending from the movement 6 extends. The hour hand 8a and the minute hand 8b are fixed to the rotating shaft 6a. The center C1 is coincident with the geometric center of the dial plate 3 in the wristwatch 1 of the present embodiment. However, the center C1 may not be necessarily the geometric center of the dial plate 3 as long as the center C1 is the rotational center of the hand 8. The hour hand 8a rotates about the center C1 once in every twelve hours, and the minute hand 8b rotates about the center C1 once in every sixty minutes.

The dial plate 3 includes a plurality of indices 3d (an example of first indices or index, hereinafter referred to as the first indices (index) 3d) for indicating time (the hand 8 points at the first indices). The first index 3d is disposed on a radial line L extending radially outwardly from the center C1 and the radial line L is provided every 30 degrees around the center C1. Each of the first indices 3d has a rectangular shape in a plan view. Pointing at the first index 3d by the hour hand 8a indicates an hour. Twelve first indices 3d are provided on the dial plate 3, each of which corresponds to each hour. The first index 3d is formed of resin, metal, mineral ore (a precious stone such as diamond, for example) or the like. The first index 3d is a convex portion protruding from the surface of the dial plate 3 to the crystal 5 (upward in a height direction H).

Two first indices 3d, 3d are arranged side by side in a position corresponding to twelve o'clock. Twelve o'clock has a special meaning different from other hours since the morning turns to afternoon and dates change at twelve o'clock. Accordingly, the two first indices 3d, 3d are arranged side by side to be distinguished from the indices at other hours to display the special meaning on the dial plate 3. Pointing at the middle of the two first indices 3d, 3d by the hour hand 8a indicates twelve o'clock. In other words, the two first indices 3d, 3d perform the function of the single first index 3d at twelve o'clock.

The case ring 4 is formed in a circular shape, and includes an inner circumferential surface 4a. As shown in FIG. 2, the inner circumferential surface 4a extends upwards from the dial plate 3 and inclined relative to the dial plate 3. The case ring 4 includes an eave 4c at the upper end of the inner circumferential surface 4a. The eave 4c radially inwardly extends in a radial direction r further from the inner circumferential surface 4a. In other words, the eave 4c is separated from the dial plate 3 in the height direction H, and extends toward the center C1 of the dial plate 3. The protruding leading edge of the eave 4c is an inner circumferential edge 4h (see FIG. 4).

The eave 4c is positioned above the first indices 3d on the dial plate 3 in the height direction H so that the eave 4c and the first indices 3d are separated from each other in the height direction H. An outer circumferential surface 4b of the case ring 4 faces the upper circular portion 2a of the case 2. The upper end of the outer circumferential surface 4b is located above the eave 4c in the height direction H. An upper surface 4g of the case ring 4 includes an outer portion 4m and an inner portion 4n. The outer portion 4m substantially horizontally extends from the upper end of the outer circumferential surface 4b. The inner portion 4n is located inside of the outer portion 4m in the radial direction r and inclined downward toward the eave 4c.

The case ring 4 includes a plurality of second indices 4d (an example of second indices or index). Each of the second indices 4d is arranged in series with the first index 3d on the dial plate 3 and on the radial line L extending radially from the center Cl. Each of the second indices 4d corresponds to each of the twelve first indices 3d on the dial plate 3. In other words, the case ring 4 includes twelve second indices 4d. The second index 4d is disposed outside of the corresponding first index 3d in the radial direction r (see FIG. 2) on the radial line L. The case ring 4 further includes a plurality of third indices 4q. The third indices 4q are markers or indicators which equally divide a portion of the case ring between the adjacent two second indices 4d, 4d into five sub-portions (every 6 degrees) along the circumferential direction. The third indices 4q may be printed on the case ring, for example.

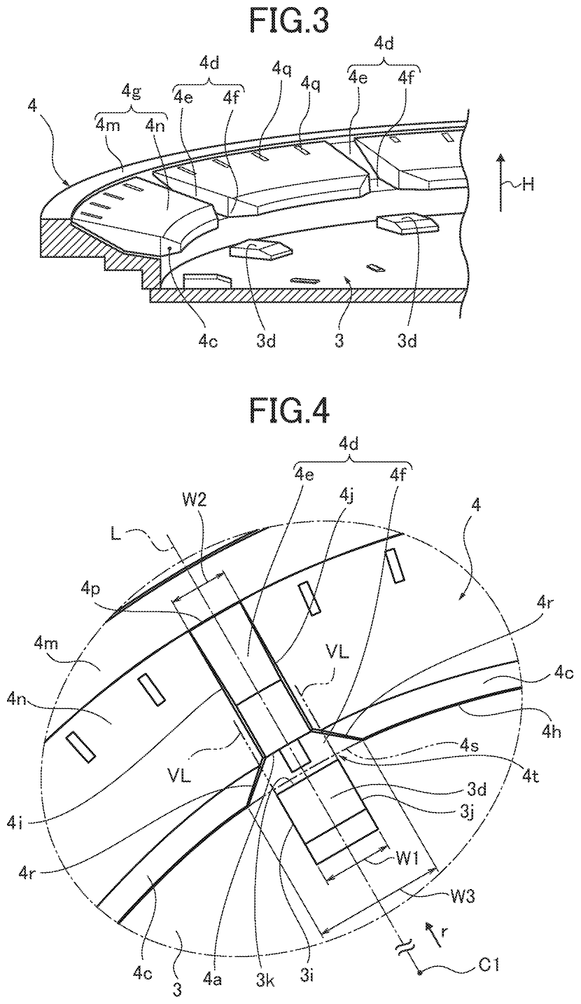

FIG. 3 is a perspective view illustrating the second indices 4d in the case ring 4. FIG. 4 is a plan view illustrating the first index 3d and the second index 4d. As shown in FIG. 4, the second index 4d includes a rectangular portion 4e and a trapezoidal portion (a wider portion) 4f in a plan view seen in the height direction of the dial plate 3. The rectangular portion 4e is disposed outward in the radial direction r, and the trapezoidal portion 4f is disposed inward in the radial direction r. The rectangular portion 4e has an elongate rectangular shape in which the dimension in a direction along the radial line L is longer than the dimension in a direction perpendicular to the radial line L. At an end 4t close to the first index 3d (hereinafter also referred to as a proximal end 4t), the trapezoidal portion 4f has a wider shape in which its width gradually increases as it gets closer to the first index 3d.

As shown in FIG. 3, the second index 4d is separated from the first index 3d in the height direction H to be located above the first index 3d. In addition, as shown in FIG. 4, the second index 4d is disposed not to overlap the first index 3d in a plan view. Note that the second index 4d may not be separated from the first index 3d in the height direction H.

As shown in FIG. 3, the rectangular portion 4e is formed on the inner portion 4n as a groove which is concave relative to the upper surface 4g of the case ring 4. As shown in FIG. 4, the rectangular portion 4e is surrounded by two contour lines 4i, 4j (hereinafter referred to as radial contour lines 4i, 4j) radially extending parallel to the radial line L from the center C1 of the dial plate 3, a line to which a contour line is projected in the plan view of FIG. 4, and a boundary line 4p (or a distal end) which forms a boundary between the outer portion 4m and the inner portion 4n of the upper surface 4g.

The trapezoidal portion 4f is a space or cutout formed on the eave 4c by cutting out the eave 4c in the height direction H. Accordingly, the trapezoidal portion 4f is also concave relative to the upper surface 4g of the case ring 4. In the trapezoidal portion 4f, the line to which the contour line is projected in the plan view of FIG. 4 corresponds to an upper base or line of the trapezoid, and a line 4s (a line which actually does not exist since the trapezoidal portion 4f is the cutout, and the line is indicated by a virtual line (a two-dot chain line)) corresponds to a lower base or line of the trapezoid. The line 4s extends the inner circumferential edge 4h of the eave 4c to the cutout in the plan view of FIG. 4. Two contour lines 4r, 4r of the trapezoidal portion 4f are inclined relative to the radial line L so that the width (i.e. dimension along a direction perpendicular to the radial direction) of the trapezoidal portion 4f gradually increases as it gets closer to the first index 3d. The two contour lines 4r, 4r correspond to two inclined legs of the trapezoid (lines connecting the ends of the upper base and the ends of the lower base). The two inclined contour lines 4r, 4r of the second index 4d are located in a side facing the first index 3d.

As shown in FIG. 4, in the second index 4d, the width W2 of the rectangular portion 4e, which is further away from the first index 3d, is constant. Accordingly, the width of the boundary line 4p (i.e. a distal end of the second index 4d) which is an outer end of the rectangular portion 4e and the width (corresponding to the length of the upper base of the trapezoidal portion 40 of the inner end of the rectangular portion 4e also have the width W2. On the other hand, in the second index 4d, an end 4t (i.e. the proximal end 4t) of the trapezoidal portion 4f closer to the first index 3d has a width W3, i.e. the width of the portion corresponding to the lower base of the trapezoidal portion 4f (i.e. the virtual line 4s of the eave 4c). The width W3 is wider than the width W2 of the portion corresponding to the upper base (W3>W2).

The first index 3d includes an end 3k (hereinafter also referred to as a proximal end 3k) closer to the second index 4d and an end (hereinafter also referred to as a distal end) further away from the second index 4d. Each of the proximal end 3k and the distal end has a width W1 which is a dimension between two contour lines 3i, 3j (hereinafter referred to as radial contour 3i, 3j) extending parallel to the radial line L. The width W1 of the first index 3d is substantially the same as the width W2 of the rectangular portion 4e in the second index 4d, but the width W1 is slightly wider than the width W2 (W2<W1). In other words, the width W2 of the rectangular portion 4e is slightly narrower than the width W1 of the first index 3d.

The width W3 of the proximal end 4t in the second index 4d (i.e. that is the portion corresponding to the lower base of the trapezoidal portion 40 is wider than the width W1 of the proximal end 3k in the first index 3d (W1<W3). As a result, virtual lines VL, VL extended from the radial contour lines 3i, 3j of the first index 3d toward the second index 4d cross the inclined contour lines 4r, 4r of the second index 4d. In addition, the length of the second index 4d in the radial direction is longer than that of the first index 3d.

According to the wristwatch 1 configured as above, even if the displacement or misalignment between the first indices 3d of the dial plate 3 and the second indices 4d of the case ring 4 occurs (i.e. the first indices 3d and the second indices 4d are relatively displaced in the circumferential direction around the center C1), such displacement can hardly be recognized.

Specifically, with regard to the two indices, i.e. the first index 3d and the second index 4d on the radial line L, the viewer looking at the wristwatch 1 recognizes the relative displacement between the first indices 3d and the second indices 4d in the circumferential direction around the center C1 when the viewer recognizes the displacement in the circumferential direction between the radial contour line 3i of the first index 3d and the radial contour line 4i of the second index 4d, or the displacement in the circumferential direction between the radial contour line 3j of the first index 3d and the radial contour line 4j of the second index 4d as shown in FIG. 4.

In this regard, in the wristwatch 1 of the present embodiment, the contour lines 4r, 4r are provided between the radial contour line 3i and the radial contour line 4i. The contour lines 4r, 4r are located at the end of the second index 4d closer to the first index 3d and inclined relative to a direction to which the radial contour line 3i and the radial contour line 4i extend (i.e. a direction to which the radial line L extends). As a result, the viewer hardly recognizes the amount of the displacement in the circumferential direction between the virtual line VL extended from the radial contour line 3i of the first index 3d and the line extended from the radial contour line 4i of the second index 4d as well as the amount of the displacement in the circumferential direction between the virtual line VL extended from the radial contour line 3j of the first index 3d and the line extended from the radial contour line 4j of the second index 4d.

Accordingly, the viewer hardly recognizes whether the amount of the displacement between one side edge of the first index 3d and one side edge of the second index 4d (i.e. between the radial contour lines 3i, 4i) and the amount of the displacement between the other side edge of the first index 3d and the other the side edge of the second index 4d (i.e. between the radial contour lines 3j, 4j) are equal or not. Therefore, according to the wristwatch 1 of the present embodiment, the displacement can hardly be recognized by the viewer who feels that the first index 3d and the second index 4d may be displaced even when the amount of the displacement between the one side edges of the indices 3d, 4d and the amount of the displacement between the other side edges of the indices 3d, 4d are not equal. This can suppress deterioration of quality in the appearance of the timepiece due to the displacement.

Further, in the wristwatch 1 of the present embodiment, the width W3 of the portion (i.e. the proximal end 4t) corresponding to the lower base of the trapezoidal portion 4f in the second index 4d is wider than the width W1 of the end (the proximal end 3k) of the first index 3d closer to the second index 4d (i.e. W1<W3). This makes the viewer difficult to recognize the size difference between the width W1 of the first index 3d and the width W2 of the rectangular portion 4e in the second index 4d (i.e. whether the widths W1, W2 have the same dimension, or one of the widths is larger than the other), and accordingly, the displacement can hardly be recognized.

In the wristwatch 1 of the present embodiment, the displacement hardly occurs between the dial plate 3 and the movement 6 but may occur between the dial plate 3 and the case ring 4. In this case, the displacement hardly occurs between the hand 8 and the first indices 3d but may occur between the hands 8 and the second indices 4d. Further, in the wristwatch 1 of the present embodiment, the end (the proximal end 4t) of the second index 4d closer to the first index 3d has the wider shape. Accordingly, a direction at which the tip of each hand 8 is pointing comes within an area of the width W3 of the trapezoidal portion 4f even if the second indices 4d are displaced in the circumferential direction. As a result, the displacement of the second indices 4d relative to the hands 8 can hardly be recognized.

Further, in the wristwatch 1 of the present embodiment, the width W2 of the rectangular portion 4e in the second index 4d is narrower than the width W1 of the first index 3d. Accordingly, even if the both side edge (i.e. the radial contour lines 3i, 3j) of the first index 3d are virtually extended, such virtual lines VL, VL cross the inclined contour lines 4r, 4r of the second index 4d.

On the other hand, if the width W2 of the rectangular portion 4e in the second index 4d is slightly wider than the width W1 of the first index 3d, and the both side edge (i.e. the radial contour lines 3i, 3j) of the first index 3d are virtually extended, such virtual lines do not cross the inclined contour lines 4r, 4r of the second index 4d. As a result, the viewer easily images a condition that the lines extend parallel to the both side edges (the radial contour lines 4i, 4j) of the rectangular portion 4e in the second index 4d. In this case, with regard to two pairs of the parallel lines (i.e. a pair of the radial contour lines 3i, 4i, and a pair of the radial contour lines 3j, 4j), the viewer easily recognizes difference between the distance between the one pair of the parallel lines and the distance between the other pair of the parallel lines compared to the case shown in FIG. 4 where the width W2 of the rectangular portion 4e in the second index 4d is slightly narrower than the width W1 of the first index 3d.

Even in the above case, the displacement between the first indices 3d and the second indices 4d becomes inconspicuous since the trapezoidal portion 4f is provided between the rectangular portion 4e of the second index 4d and the first index 3d. In other words, the radial distance between the radial contour line 3i and the radial contour line 4i is separated by the trapezoidal portion 4f provided between the radial contour lines 3i, 4i, so that comparison of the position of the radial contour line 3i to the position of the radial contour line 4i can be avoided. Further, the displacement between the trapezoidal portion 4f and the radial contour line 3i or the radial contour line 4i can hardly be recognized since the contour lines 4r, 4r which form the trapezoidal portion 4f are not parallel to the radial contour line 3i and the radial contour line 4i. The above descriptions are also applied to the relation between the radial contour lines 3j, 4j and the trapezoidal portion 4f.

As described above, in the wristwatch 1 of the present embodiment, the virtual lines VL, VL extended from the radial contour lines 3i, 3j of the first index 3d cross the inclined contour lines 4r, 4r of the second index 4d, so that the viewer can hardly image a condition that the virtual lines extend to the radial contour lines 4i, 4j of the rectangular portion 4e in the second index 4d. This makes the displacement more inconspicuous.

The above displacement would become conspicuous if the width W3 of the trapezoidal portion 4f is equal to or narrower than the width W1 of the first index 3d to form a trapezoid with a shorter lower base, while the width of the rectangular portion in the second index 4d remains as the width W2. In other words, setting the width W3 of the trapezoidal portion 4f as described above, the contour lines 4r, 4r in the trapezoidal portion 4f inclines toward a center in the width direction as it gets closer to the center C1. The trapezoid having the shorter lower base than the upper base tapers like an arrow head. Accordingly, the trapezoidal portion 4f having the arrow head shape points at a portion displaced from the center in the width direction when the above displacement occurs. As a result, the displacement can be easily recognized.

In addition, as shown in FIG. 1, the indices (i.e. the first indices 3d′, the second index 4d′) corresponding to the twelve o'clock position have similar configurations and cause similar effects as the indices (i.e. the first index 3d, the second index 4d) corresponding to the other hour positions, but differ from the indices at the other hour positions only in terms of details of the configuration.

Here, the first indices 3d′ of the dial plate 3 at the twelve o'clock position may be regarded as the indices consisting of the two first indices 3d, 3d arranged along the direction perpendicular to the radial line L. However, the first indices 3d′ may be regarded as a single rectangular first index 3d′ having a width more than twice as wide as that of the first index 3d and including a concave cutout 3s in the center of the width.

Similarly, the second indices 4d′ of the case ring 4 at the twelve o'clock position may be regarded as a single bigger second index 4d′ having a width more than twice as wide as that of the second index 4d and including a convex bar 4z in the center of the width.

It can be said that the first index 3d′ and the second index 4d′ regarded as described above have the same configuration as the indices corresponding to the other hour positions. Specifically, the first index 3d′ is configured to protrude toward the crystal 5 from the surface of the dial plate 3. On the other hand, in the second index 4d′ of the case ring 4 at the twelve o'clock position, the rectangular portion is formed as a concave groove relative to the upper surface 4g of the case ring 4 except the bar in the center of the width, and the trapezoidal portion has a space or cutout formed by cutting out the eave 4c in the height direction H. The width of the lower base of the trapezoidal portion in the second index 4d′ is wider than the width of the first index 3d′, and the width of the rectangular portion in the second index 4d′ is narrower than that of the first index 3d′.

Accordingly, the first index 3d′ differs from the first indices 3d at the other hour positions in that the cutout 3z is provided in the center of the width direction. The second index 4d′ differs from the second indices 4d at the other hour positions in that the bar 4z is provided in the center of the width direction. However, even with the above differences, common configurations of the first and second indices 3d′, 4d′ with the indices (i.e. the first indices 3d and the second indices 4d) at the other hour positions can make the displacement in the circumferential direction between the first indices 3d′ and the second indices 4d′ inconspicuous. The indices (i.e. the first index 3d′ and the second index 4d′) at the twelve o'clock position may have the same configuration as the indices (i.e. the first indices 3d and the second indices 4d) at the other hour positions.

In the timepiece according to the present disclosure, the width W2 of the end (the distal end) in the second index 4d further away from the first index 3d may not be narrower than the width W1 of the end (the proximal end 3k) of the first index 3d closer to the second index 4d, but the width W2 of the second index 4d may be equal to or wider than the width W1 of the first index 3d.

Further, in the wristwatch 1 of the present embodiment, the second indices 4d are separated from the first indices 3d in the height direction H and located above the first indices 3d as shown in FIGS. 2, 3, and the second indices 4d are disposed not to overlap the first indices 3d in the plan view as shown in FIG. 4. Accordingly, the viewer feels that the indices 3d, 4d are spatially displaced when viewed in a line of sight in an oblique direction with respect to the dial plate 3 as shown in FIG. 3, so that the displacement can be inconspicuous even if the first index indices 3d and the second indices 4d are displaced in the circumferential direction.

In the timepiece according to the present disclosure, the second indices 4d may not be separated from the first indices 3d in the height direction H and may not be located above the first indices 3d, but the first indices 3d may be disposed in the same height as the second indices 4d. Further in the timepiece according to the present disclosure, the second indices 4d may not be disposed not to overlap the first indices 3d in the plan view shown in FIG. 4. Specifically, in the timepiece according to the present disclosure, the second indices 4d may be disposed to partially overlap the first indices 3d in the plan view. Note that the first indices 3d may overlap only the trapezoidal portions 4f of the second indices 4d in the plan view but may not overlap the rectangular portion 4e.

Moreover, in the wristwatch 1 of the present embodiment, each of the first indices 3d is formed to be convex in the height direction H, and each of the second indices 4d is formed to be concave in the height direction H as shown in FIGS. 2, 3. Accordingly, the viewer sees the side surfaces of indices 3d, 4d when viewed in a line of sight in an oblique direction with respect to the dial plate 3 as shown in FIG. 3, so that the radial contour lines 3j, 3j, 4i, 4j of the indices 3d, 4d in the plan view can hardly be identified. As a result, the displacement can be inconspicuous even if the first index indices 3d and the second indices 4d are displaced in the circumferential direction.

In addition, there are big differences in appearance between the radial contour lines 3j, 3j of the convex first index 3d and the radial contour lines 4i, 4j of the concave second index 4d when viewed in the line of sight in the oblique direction, so that the combination of the convex shape and the concave shape can makes the displacement more inconspicuous.

Note that in the timepiece according to the present disclosure, each of the first indices 3d may not be convex relative to the dial plate 3 in the height direction H, but may be provided in the same height as the surface of the dial plate 3 by printing or transfer printing, for example. Similarly, in the timepiece according to the present disclosure, each of the second indices 4d may not be concave relative to the upper surface 4g of the case ring 4 in the height direction H, but may be provided in the same height as the upper surface 4g of the case ring 4 by printing or transfer printing, for example. Alternatively, each of the second indices 4d may be convex from the upper surface 4g in the height direction H as the first index 3d. It is preferable not to form the first index 3d and the second index 4d flat but to form at least one of the first index 3d and the second index 4d stereoscopically (in a convex shape).

Further, in the wristwatch 1 of the present embodiment, the case ring 4 includes the eave 4c extending toward the center C1 of the dial plate 3 upwardly separated from the dial plate 3 in the height direction H as shown in FIGS. 2, 3. Accordingly, the eave 4c shades the incident light through the crystal 5 to cast a shadow on the dial plate 3. Thereby, the shadow gives a stereoscopic effect to the dial plate 3 on the appearance of the wristwatch 1. In addition, the eave 4c is cut out in a shape corresponding to the trapezoidal portion 4f of the second index 4d, so that a part of each first index 3d (especially, an outer circumferential portion) is not covered by the shadow cast on the dial plate 3 by the eave 4c. As a result, the first indices 3d can be seen with a clear impression and quality in appearance can be improved.

Note that in the timepiece according to the present disclosure, the eave 4c may not be cut out in the shape corresponding to the trapezoidal portion 4f of the second index 4d. In addition, the case ring 4 of the timepiece according to the present disclosure may not include the eave 4c. In this case, the timepiece may have a shape (a configuration in which the eave 4c does not substantially form an eave) in which the bottom surface of the eave 4c is extended downward in the height direction H (i.e. a direction approaching the upper surface of the dial plate 3) to the upper surface of the dial plate, or a shape in which the inner circumferential surface 4a is upwardly extended to the upper surface 4g to exclude the eave 4c, for example. In the case without the eave 4c, the trapezoidal portion 4f may be formed at the end (i.e. the proximal end 4t) of the rectangular portion 4e closer to the first index 3d.

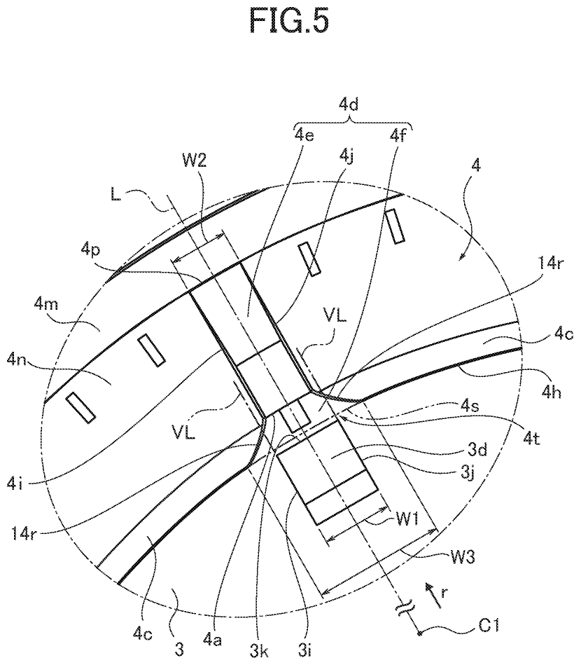

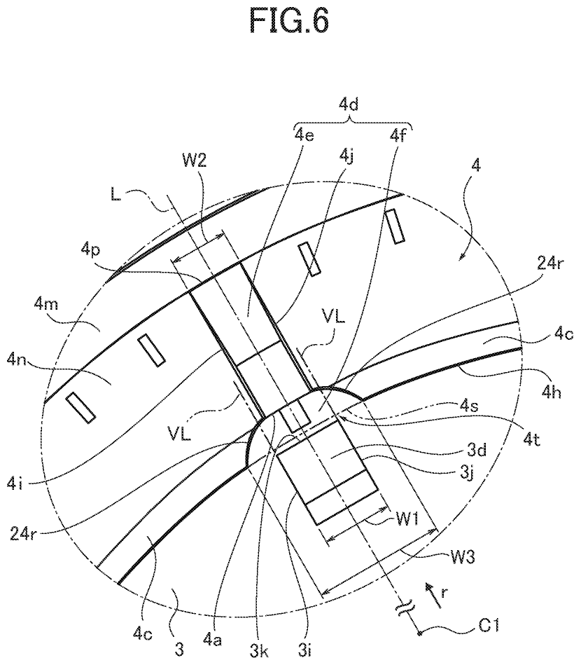

In the wristwatch 1 of the present embodiment, the wider shape of the second index 4d is formed as the trapezoidal portion 4f, but the wider shape of the timepiece according to the present disclosure is not limited to the trapezoid. Specifically, in the trapezoidal portion 4f, the two contour lines 4r, 4r corresponding to the inclined legs of the trapezoid are straight but the two lines which forms the wider shape may be curved like an arc. For example, as shown in FIG. 5, contour lines 14r, 14r of the second index 4d may be curved and convex relative to the first index 3d. Alternatively, as shown in FIG. 6, contour lines 24r, 24r of the second index 4d may be curved and concave relative to the first index 3d. Note that in the alternative examples, the two contour lines may be symmetric or asymmetric relative to the radial line L.

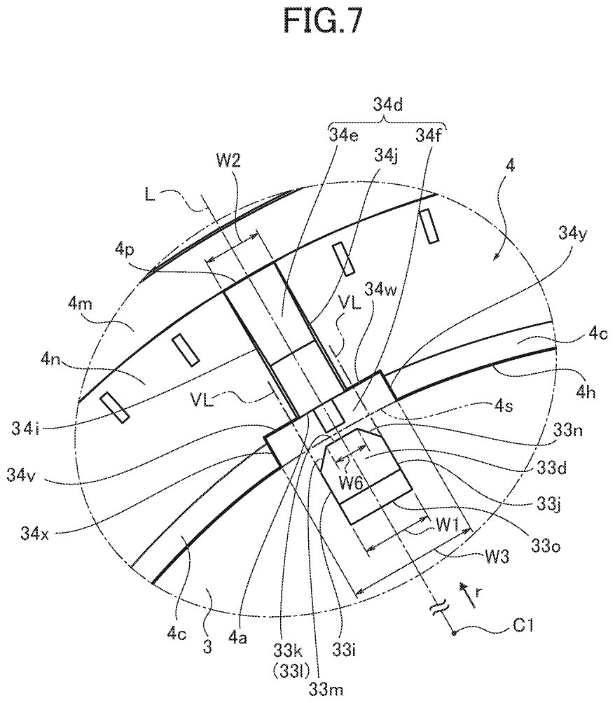

Next, a second embodiment of the present disclosure will be described with reference to FIG. 7. Note that the same reference numerals are used to the same elements as those in the above embodiment, and redundant explanations are to be omitted. In this embodiment, first indices 33d and second indices 34d differ from the first indices 3d and the second indices 4d in the first embodiment. Specifically, each of the second indices 34d includes a first rectangular portion 34e and a second rectangular portion (the wider portion) 34f to form a substantially T-shaped index. The first rectangular portion 34e is disposed outward in the radial direction r and extends along the radial line L. The second rectangular portion (a wider portion) 34f is disposed inward in the radial direction r and extends in a direction perpendicular to the radial line L. The first rectangular portion 34e is the same as the rectangular portion 4e in the first embodiment. The second rectangular portion 34f is formed in the eave 4c. The second rectangular portion 34f includes first contour lines 34v, 34w and second contour lines 34x, 34y at each side thereof. The first contour lines 34v, 34w are perpendicular to the radial line L. The second contour lines 34x, 34y are parallel to the radial line L and perpendicular to the first contour lines 34v, 34w. One end of each first contour line 34v, 34w is connected to a radially inner end of each contour line 34i, 34j in the first rectangular portion 34e, and the other end is connected to a radially outer end of each second contour line 34x, 34y, respectively.

Each of the first indices 33d includes contour lines 33i, 33j, 331, 33m, 33n, 33o to form a hexagonal shape in the plan view of FIG. 7. The contour lines 33i, 33j correspond to the radial contour lines 3i, 3j in the first embodiment, and extends parallel to the radial line L and the second contour lines 34x, 34y of the second index 34d. The contour line 331 at a proximal end 33k faces the second index 34d and extends parallel to the first contour lines 34v, 34w of the second index 34d. Similarly, the contour line 33o at the distal end extends parallel to the first contour lines 34v, 34w. The contour line 33m is disposed between the contour line 331 and the contour line 33i, and the contour line 33n is disposed between the contour line 331 and the contour line 33j. The contour lines 33m, 33n are inclined relative to the second contour lines 34x, 34y of the second index 34d and the radial line L. In other words, the two contour lines 33m, 33n are placed at a side of the first index 33d facing the second index 34d. Accordingly, the first index 33d is tapered toward the second index 34d, and a width W6 of the contour line 331 at the proximal end 33k is smaller than the width W1 between the contour lines 33i, 33j. The width W6 of the first index 33d is the substantially same as the width W2 of the first rectangular portion 34e in the second index 34d but slightly narrower than the width W2.

According to the second embodiment, the second rectangular portion 34f of the second index 34d is located between the contour lines 33i, 33j of the first index 33d and the contour lines 34i, 34j of the second index 34d. Further, the contour lines 33m, 33n of the first index 33d are inclined relative to the second contour lines 34x, 34y and do not extend parallel to the second contour lines 34x, 34y. Accordingly, the viewer can hardly recognize the amount of the displacement in the circumferential direction between the virtual lines VL, VL extended from the contour lines 33i, 33j of the first index 33d and the lines extended from the contour lines 34i, 34j of the second index 34d. Also, the viewer can hardly recognize the amount of the displacement in the circumferential direction between the contour lines 33i, 33j of the first index 33d and the contour lines 34x, 34y of the second index 34d.

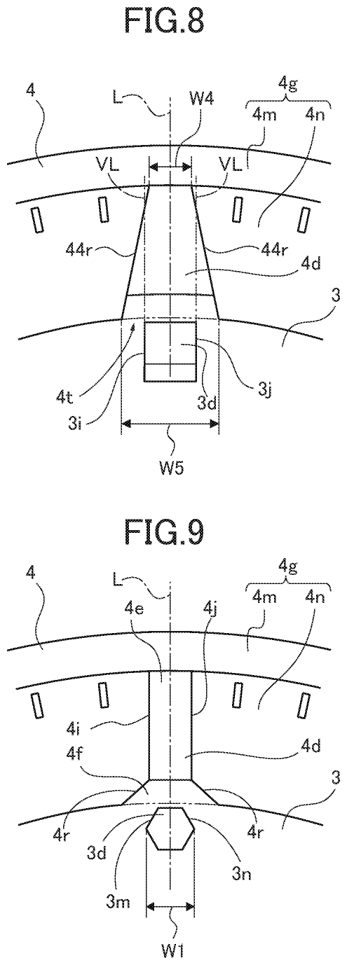

Alternatively, in the timepiece according to the present disclosure, the second index 4d shown in FIG. 1 to FIG. 6 may not include the rectangular portion 4e and the trapezoidal portion 4f FIG. 8 is a plan view corresponding to FIG. 4 and illustrates another embodiment wherein the second index 4d does not include the rectangular portion 4e, and the entire second index 4d is configured from a trapezoidal portion having a shape which becomes wider as it approaches the first index 3d. In the embodiment shown in FIG. 8, the second index 4d is entirely configured in a trapezoid shape. The second index 4d includes contour lines 44r, 44r which are inclined relative to the radial line L and correspond to the two inclined legs of the trapezoid. The two contour lines 44r, 44r extend toward the first index 3d. In the embodiment shown in FIG. 8, a width W4 of a portion corresponding to the upper base of the trapezoid has the same size as the width W2 of the rectangular portion 4e shown in FIG. 4 and a width W5 of a portion (i.e. the proximal end 4t) corresponding to the lower base of the trapezoid has the same size as the width W3 of the trapezoidal portion 4f shown in FIG. 4, for example. In other words, the width of the second index 4d gradually increases from the distal end to the proximal end 4t. The virtual lines VL, VL, which are extended from the radial contour lines 3i, 3j of the first index 3d toward the second index 4d, cross the inclined contour lines 44r, 44r. According to this embodiment, the viewer can hardly recognize the amount of the displacement in the circumferential direction between the first index 3d and the second index 4d since the radial contour lines 3i, 3j of the first index 3d and the inclined contour lines 44r, 44r of the second index 4d are not parallel to each other.

Similarly, in the timepiece according to the present disclosure, the first indices 3d, 33d are not limited to the rectangular shape. FIG. 9 corresponds to FIG. 4 and illustrates yet another embodiment wherein a first index 3d is a hexagon. In the timepiece according to the present disclosure, as shown in FIG. 9, the first index 3d may be entirely configured in a shape other than rectangular such as trapezoidal, polygonal, circular, star and the like. In this case, the width W1 of the first index 3d has the maximum dimension along a direction perpendicular to the radial line L. In the embodiment shown in FIG. 9, the first index 3d has a hexagon shape, and includes contour lines 3m, 3n inclined relative to the radial line L. The inclined contour lines 3m, 3n are placed to face the inclined contour lines 4r, 4r of the trapezoidal portion 4f in the second index 4d. However, the inclined contour lines 3m, 3n of the first index 3d and the inclined contour lines 4r, 4r of the second index 4d are not parallel to each other. Further, none of the contour lines which define the first index 3d are parallel to the inclined contour lines 4r, 4r of the trapezoidal portion 4f According to the embodiment shown in FIG. 9, the viewer can hardly recognize the amount of the displacement in the circumferential direction between the first index 3d and the second index 4d.

Further, the wristwatch 1 of the present embodiment can adopt the design wherein the second indices 4d, 34d are longer than the first indices 3d, 33d along the radial line L because of the effect that the displacement in the circumferential direction between the first indices 3d, 33d and the second indices 4d, 34d can hardly be recognized. Moreover, the first indices 3d, 33d and the second indices 4d, 34d can be arranged in series to form relatively longer indices along the radial line L because of the design wherein the second indices 4d, 34d are longer than the first indices 3d, 33d, which can give an impression which makes the indices noticeable and distinguishing.

The timepiece according to the present disclosure is not limited to one wherein the length of the second indices 4d, 34d along the radial line L is longer than that of the first indices 3d, 33d, but the length of the second indices 4d, 34d along the radial line L may be equal to or shorter than that of the first indices 3d, 33d.

In addition, the above effect of the present embodiment can be obtained by a general wristwatch having no bezel and the like since the second indices 4d, 34d are provided on the case ring 4 in the wristwatch 1.

Note that in the timepiece according to the present disclosure, the circular member is not limited to the case ring 4 of the wristwatch 1 in the above embodiments, but in a timepiece without the case ring 4, the bezel, the case 2 or the like may be the circular member. In this case, the second indices 4d, 34d may be disposed in the bezel or the case 2. Particularly, it is effective for a timepiece in which the rotatable bezel having a click mechanism is attached to the case, and the bezel stops at positions where the indices of the dial plate face the indices of the bezel. This is because such a timepiece has more parts for the rotation mechanism, it can be easily affected by accumulation of tolerances of the parts, which make it difficult to precisely set the position where the rotation of the bezel stops, and the indices of the bezel may easily be misaligned relative to the indices of the dial plate.

In addition, the circular member in the timepiece according to the present disclosure may not necessarily be a complete ring but may be an incomplete ring having at least one cutout. In short, the circular member in the timepiece according to the present disclosure may not be a completely connected ring as long as the circular member is disposed in the outer circumferential portion of the dial plate or radially outward of the dial plate and is arranged relative to at least the first indices in series.

Further, the indices (the first index and the second index) of the present disclosure may not be applied to all indices (the first index 3d, the second index 4d) corresponding all hours like the wristwatch 1, but may only be applied to some noticeable indices (indices corresponding to twelve o'clock, three o'clock, six o'clock, nine o'clock, for example).

Alternatively, the indices of the present disclosure may be applied to some of indices which are easily displaced or misaligned. Specifically, for example, when the case ring 4 is set to the case 2 of the wristwatch 1 based on the twelve o'clock position of the case ring 4 (the twelve o'clock position of the case ring 4 is set to correspond to a predetermined position of the case 2 (a position corresponding to twelve o'clock)), and the displacement is likely to occur at the six o'clock position opposite to the twelve o'clock position with the center C1 therebetween, the present disclosure may be applied at least to the index at the six o'clock position.

The above embodiments are applied to the wristwatch as an example of the timepiece according to the present disclosure. However, the timepiece according to the present disclosure is not limited to the wristwatch but may be applied to portable watches such as a pocket watch and other types of watches such as non-portable watches.

What is claimed is:

1. A timepiece comprising:
a dial plate comprising a first index on a radial line outwardly extending from a center; and
a circular member disposed outside of the dial plate and extending at least partially circularly, the circular member comprising a second index arranged in series with the first index on the radial line,
wherein the second index comprises a proximal end facing the first index; and a distal end opposite the proximal end,
wherein a width of the proximal end is wider than that of the distal end in a plan view as seen in a height direction of the dial plate, and
wherein the width of the proximal end of the second index is wider than that of a proximal end of the first index facing the second index.

2. The timepiece according to claim 1,
wherein at least one of the first index and the second index comprises, on a side facing the other of the first index and the second index, an inclined contour line relative to the radial line and provided each side of the radial line.

3. The timepiece according to claim 1,
wherein the second index comprises, on at least a side facing the first index, an inclined contour line relative to the radial line and provided each side of the radial line,
wherein the first index comprises a contour line provided each side of the radial line and extending parallel to the radial line, and
wherein virtual lines extended from the contour lines of the first index toward the second index cross the inclined contour lines of the second index.

4. The timepiece according to claim 1,
wherein the second index comprises a rectangular portion extending along the radial line in the plan view, and a wider portion at the proximal end, and
wherein a width of the wider portion gradually increases toward the first index.

5. The timepiece according to claim 3,
wherein the inclined contour lines of the second index are curved and convex relative to the first index.

6. The timepiece according to claim 3,
wherein the inclined contour lines of the second index are curved and concave relative to the first index.

7. The timepiece according to claim 1,
wherein a width of the second index gradually increases from the distal end to the proximal end.

8. The timepiece according to claim 2,
wherein the second index comprises:
a first rectangular portion extending along the radial line in the plan view; and
a second rectangular portion provided at the proximal end and extending perpendicular to the radial line in the plan view, and
wherein the first index comprises the inclined contour lines are provided on a side facing the second index.

9. The timepiece according to claim 1,
wherein a width of the distal end in the second index is equal to or narrower than that of the proximal end of the first index.

10. The timepiece according to claim 1,
wherein the second index is separated upward in the height direction from the first index, and
wherein the second index is disposed not to overlap the first index in the plan view.

11. The timepiece according to claim 1,
wherein the first index is flat or convex in the height direction, and the second index is concave in the height direction.

12. The timepiece according to claim 10,
wherein the second index comprises a rectangular portion extending along the radial line in the plan view, and a wider portion comprising the proximal end,
wherein the circular member comprises an eave separated upward in the height direction from the dial plate and extending toward the center of the dial plate, and
wherein the eave is cut out in a shape corresponding to that of the wider portion.

13. The timepiece according to claim 1,
wherein a length of the second index along the radial line is longer than that of the first index.

14. The timepiece according to claim 1, wherein the circular member is a case ring.

15. The timepiece according to claim 2,
wherein the first index comprises the inclined lines on a side facing the second index and the second index comprises the inclined lines on a side facing the first index, and
wherein the inclined lines of the first index are not parallel to the inclined lines of the second index.
